(19) United States
(12) Patent Application Publication
(10) Pub. No.: US 2012/0203448 A1
(43) Pub. Date: Aug. 9, 2012

(54) SYSTEMS AND METHODS FOR PROVIDING ITP CLEARANCE INFORMATION

(75) Inventors: Dave Pepitone, Sun City West, AZ (US); Emmanuel Letsu-Dake, Shakopee, MN (US); Donald Singer, Peoria, AZ (US); Patrick Mulhall, Scottsdale, AZ (US)

(73) Assignee: HONEYWELL INTERNATIONAL INC., Moorristown, NJ (US)

(21) Appl. No.: 13/022,000

(22) Filed: Feb. 7, 2011

(51) Int. Cl. G06F 19/00

(52) U.S. Cl. 701/120

(57) ABSTRACT

Methods and systems for providing improved In-Trails Procedure (ITP) or standard (STD) transition information on a display with a vertical profile view. In an exemplary embodiment, a user interface located on a host aircraft receives a user selection of a desired altitude. A processor on the host aircraft receives information from one or more proximate target aircraft via a communications system on the host aircraft and receives host aircraft information from one or more other systems located on the host aircraft. The processor generates a graphical user interface display for presentation on a display coupled to the processing device. The graphical user interface display includes a vertical profile view that shows a valid or invalid indication for an In-Trails Procedure (ITP) or standard (STD) transition to the altitude associated with the received desired altitude based on the received proximate target aircraft and host aircraft information.

### BACKGROUND OF THE INVENTION

Efficient oceanic operations normally require flight level changes. Climbs or descents provide optimal performance to take advantage of favorable winds or to avoid turbulence or other weather anomalies.

Current oceanic operations limit opportunities for flight level changes for a number of reasons:
Flights operate along the same routes at about the same time (locally dense traffic); and
Reduced surveillance performance (compared with radar) results in large separation minima for safe procedural separation.

Automatic dependent surveillance-broadcast (ADS-B) in-trail procedures (ITP) are airborne ADS-B-enabled climbs and descents through otherwise blocked flight levels. ITP is based on an approved International Civil Aviation Organization (ICAO) procedure whereby a controller separates aircraft based on information derived from cockpit sources that is relayed by the flight crew.

ITP allows a leading or following aircraft on the same track to climb or descend to a desired flight level through flight levels occupied by other aircraft at separation distances less than those required for a standard (STD) climb/descent procedure. An ITP display enables a flight crew to determine if specific criteria for an ITP climb/descent are met with respect to one or two reference aircraft at intervening flight levels. These criteria ensure that the spacing between the estimated positions of the ITP aircraft and reference aircraft always exceeds the ITP separation minimum of 10 NM, while vertical separation does not exist during the climb or descent. Once the flight crew has established that the ITP criteria are met, they request an ITP climb or descent, identifying any reference aircraft in the clearance request. Air Traffic Control (ATC) must determine if standard separation will be met for all aircraft at the requested flight level—and at all flight levels between the initial flight level and the requested flight level. If so, a standard (non-ITP) flight level change clearance is likely to be granted. Otherwise, if the reference aircraft are the only blocking aircraft, the controller evaluates the ITP request. ATC determines if the reference aircraft have been cleared to change speed or change flight level or are about to reach a point at which a significant change of track will occur. The controller also ensures that the requesting aircraft is not referenced in another procedure. ATC also ensures that the positive Mach difference with the reference aircraft is no greater than 0.06 Mach. If each of these criteria is satisfied, then ATC may issue the ITP flight level change clearance.

Current ITP displays fail to provide adequate feedback that would be very helpful to a crew wanting to change altitudes. Thus, flight crews have difficulty planning tasks in order to optimize oceanic climbs/descents.

### SUMMARY OF THE INVENTION

The present invention provides methods and systems for providing improved In-Trails Procedure (ITP) or standard (STD) transition information on a display with a vertical profile view. In an exemplary embodiment, a user interface located on a host aircraft receives a user selection of a desired altitude. A processor on the host aircraft receives information from one or more proximate target aircraft via a communications system on the host aircraft and receives host aircraft information from one or more other systems located on the host aircraft. The processor generates a graphical user interface display for presentation on a display coupled to the processing device. The graphical user interface display includes a vertical profile view that shows a valid or invalid indication for an In-Trails Procedure (ITP) or standard (STD) transition to the altitude associated with the received desired altitude based on the received proximate target aircraft and host aircraft information.

In one aspect of the invention, the indication includes a message box positioned in the vertical profile view based on the position of a region of airspace associated with the message box.

In another aspect of the invention, the indication includes a boundary box based on the region of airspace associated with the message box.

In still another aspect of the invention, the indication presents time or distance information of when the ITP transition or the STD transition to the altitude associated with the received desired altitude will be valid or will cease to be valid.

### BRIEF DESCRIPTION OF THE DRAWINGS

Preferred and alternative embodiments of the present invention are described in detail below with reference to the following drawings:

FIG. 1 is a block diagram of an exemplary system formed in accordance with an embodiment of the present invention; and

FIGS. 2-9 are exemplary screen shots produced by the system shown in FIG. 1.

### DETAILED DESCRIPTION OF THE INVENTION

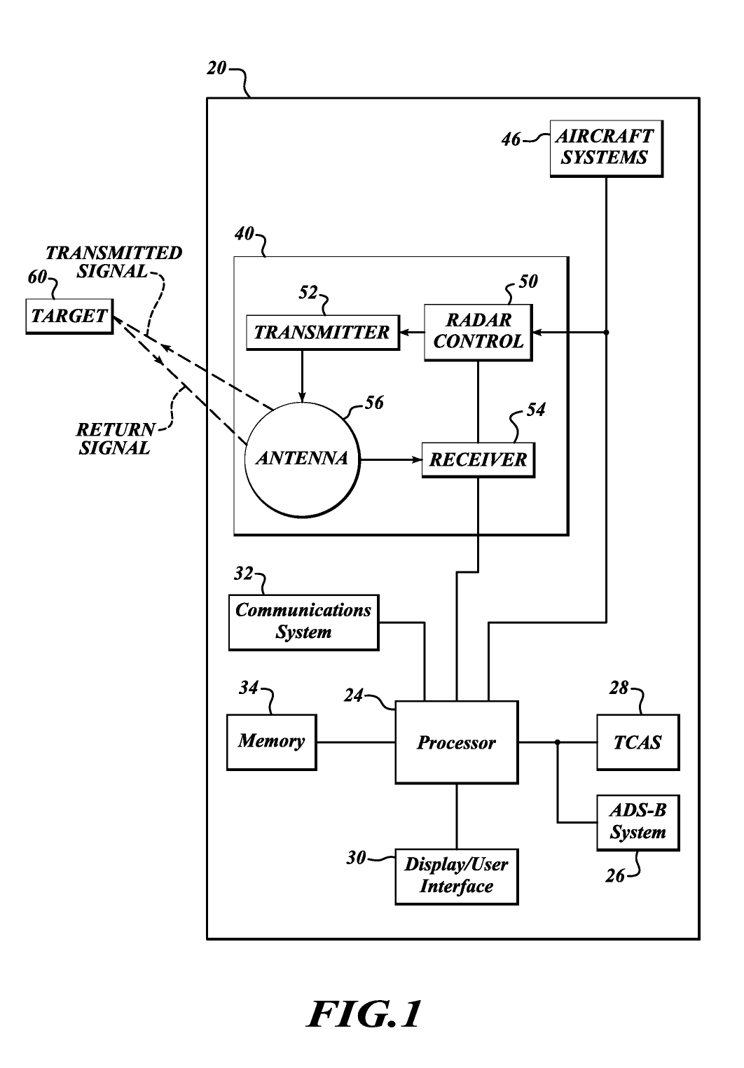

FIG. 1 illustrates an embodiment of a system for providing improved in-trail procedures (ITP) functionality on an aircraft 20. The exemplary system includes a weather radar system 40 (optional) and a processor 24 that is in signal communication with the weather radar system 40, an automatic dependent surveillance-broadcast (ADS-B) system 26, a traffic collision avoidance system (TCAS) 28 (optional), a display device with a user interface 30, a communications system 32, and memory 34. The processor 24 may be connected to other aircraft systems 46, such as a Global Positioning System (GPS) or comparable device, for retrieving various flight information (e.g., position and speed information).

The processor 24 receives information of other aircraft in the vicinity of the aircraft 20 via the ADS-B system 26 and, if included, the TCAS 28. In another embodiment, the TCAS 28 includes the ADS-B functionality and the processor 24 is included in the TCAS 28. The processor 24 presents the received other aircraft (target) information on the display device and user interface 30. Pilots interact with the processor 24 using the user interface 30, such as a cursor control device or a touch-screen display, for analyzing and sending ITP change of altitude requests to a controller authority via the communications system 32. This will be shown in more detail below in the following figures.

An example of the radar system 40 includes a radar controller 50, a transmitter 52, a receiver 54, and an antenna 56. The radar controller 50 controls the transmitter 52 and the receiver 54 for performing the sending and receiving of signals through the antenna 56. The weather radar system 40 and the processor 24 are in signal communication with the other aircraft systems 46.

The radar controller 50 or comparable processor calculates the distance of weather objects (target 60) relative to the antenna 56, based upon the length of time the transmitted signal pulse takes in the transition from the antenna 56 to the target 60 and back to the antenna 56 (i.e., reflectivity signal). The relationship between distance and time is linear as the velocity of the signal is constant, approximately the speed of light in a vacuum.

In one embodiment, the memory 34 includes a three-dimensional volumetric buffer for storing the reflectivity data from the receiver 54. The processor 24 has the capabilities of inferring lightning, hail, or turbulence based on the reflectivity data stored in the volumetric buffer. The processor 24, having access to the volumetric buffer, provides weather and wake vortex information to the ITP display device 30. Copending U.S. patent application Ser. Nos. 12/640,976 and 12/641,149, both filed Dec. 17, 2009, are hereby incorporated by reference.

An exemplary weather radar system 40 is Honeywell's IntuVue™ Weather Radar, which encompasses a three-dimensional volumetric buffer. The radar system 40 continuously scans the entire three-dimensional space in front of the aircraft 20 and stores all reflectivity data in an earth-referenced, three-dimensional (or “volumetric”) memory buffer (memory 34). The buffer is continuously updated with reflectivity data from new scans. The data stored in the buffer are compensated for aircraft movement (speed, heading, altitude). The data in the buffer are updated at a rate of every 30 seconds, for example. The three-dimensional method employs a scanning scheme that provides full coverage over a total of −15 to +15 degrees tilt control range. Reflectivity data are extracted from the buffer to generate the desired display views without having to make (and wait for) view-specific antenna scans. In one embodiment, this extraction and image generation are performed at one-second intervals (compared to four seconds for conventional radar). With the three-dimensional volumetric buffer data, the display presentation is not constrained to a single tilt-plane that is inherent to conventional radar.

The processor 24 generates an ITP vertical profile view that is presented on a vertical situation awareness display (VSAD) and/or three-dimensional display device (the display device 30). The ITP vertical profile view includes:

airborne three-dimensional weather reflectivity data;

airborne weather hazard information, such as presence of turbulence, convective activity, hail, lightning;

predictive wake vortex information;

data-linked winds-aloft data;

data-linked weather (service provided);

data-linked weather from other aircraft (e.g., pilot reports (PIREPS), temp, pressure); and/or

information about when a window for performing an ITP or standard (STD) altitude will be available or will cease to be available.

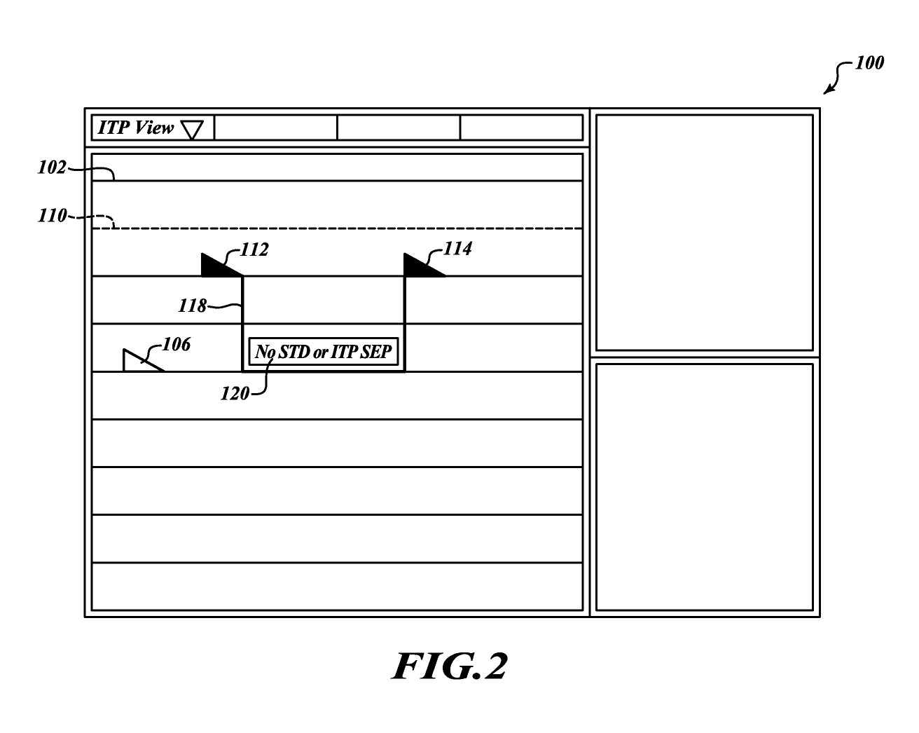

FIG. 2 illustrates an exemplary ITP display 100 that shows in a vertical profile view section 102 an own-ship symbol 106 presented approximately in the middle vertically of the vertical profile view section 102. In this example, the pilot has selected (using the user interface 30) an altitude to which they desire to transition. This desired altitude is indicated by the dashed altitude line 110. After the pilot has selected the desired altitude (see the altitude line 110), the processor 24 determines if an ITP or STD climb procedure is available out to a predefined (or user selectable) distance from the present position of the aircraft 20. In this example, the processor 24 has determined that an ITP or STD climb to the desired altitude is not possible in the column of space between the aircraft associated with the other aircraft icons 112, 114 due to information received from those other aircraft and the own-ship's current flight information.

The processor 24 receives flight information from the aircraft associated with the other aircraft icons 112, 114 via the ADS-B system 26 and the own-ship information via the other aircraft systems 46 in order to determine if an ITP or STD transition is possible within the column of space between the two aircraft (icons 112, 114). This determination can be made for other columns of space not occupied by other aircraft. Some of the information that the processor 24 uses in order to make this determination includes the location and current airspeeds of the other aircraft as well as the current airspeed of the own-ship 20. The indication displayed on the vertical profile view section 102 that indicates that there is no STD or ITP separation, in order to perform a transition to the desired altitude, includes a box or a partial box 118 that links the two other aircraft icons 112, 114 and within that box 118 is a text window 120 that includes text stating that no STD or ITP separation exists.

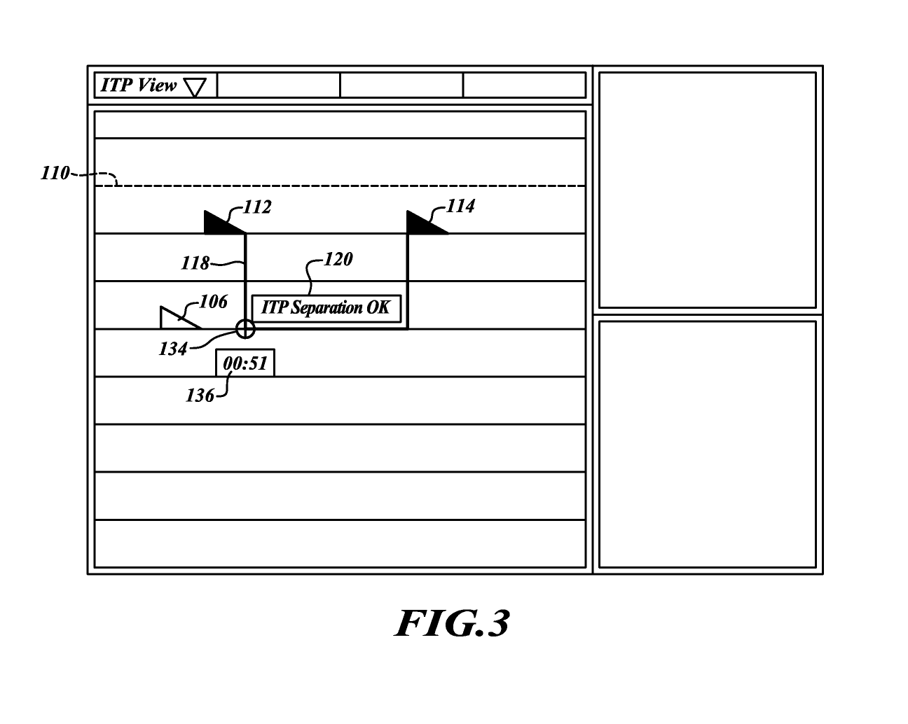

FIG. 3 illustrates an example that is similar to that shown in FIG. 2, except that the processor 24 has determined that the volume of space between the two other aircraft does provide adequate ITP separation in order to perform the transition to the desired altitude. This is indicated by the text within the text window 120 indicating that ITP separation is okay. In one embodiment, the color and/or shading of the text window 120 when ITP (or STD) separation is valid are different from those when ITP (or STD) separation is not okay (see FIG. 2). The lower left corner of the linking box 118 is uniquely identified with an icon 134 and a time and/or distance window 136, if ITP separation does not currently exist but will exist at some time in the future, as determined by the processor 24, based on all the received information. The time and/or distance window 136 identifies either a countdown of time as to when the volume of space between the two other aircraft will provide a valid ITP separation or the amount of distance that the current aircraft must travel before the ITP separation for the volume of space between the two other aircraft is valid.

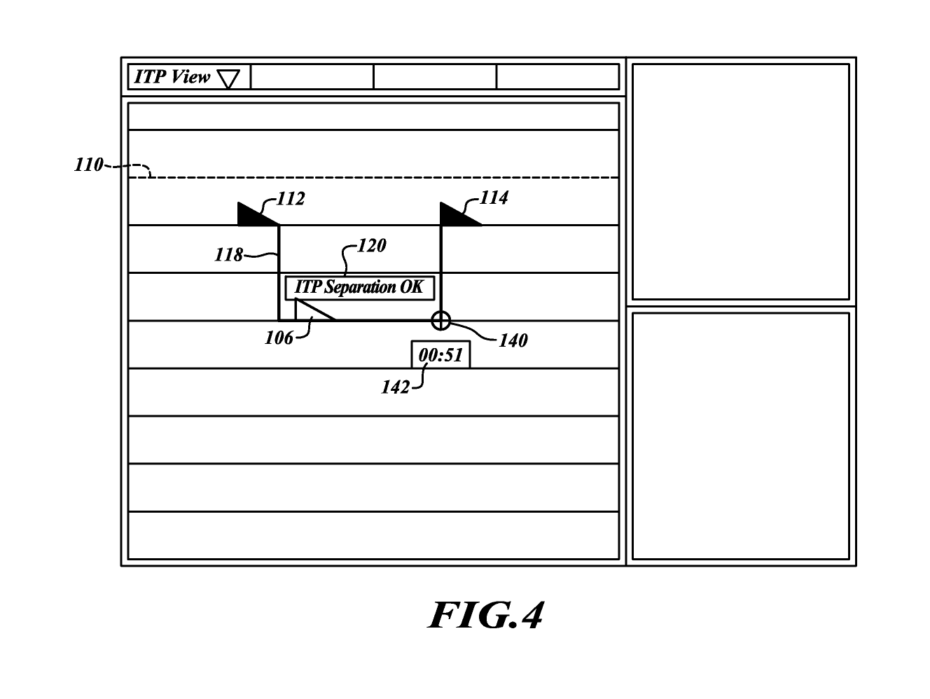

FIG. 4 illustrates a situation where the own-ship (the icon 106) is within the volume of space between two other aircraft and the pilot of the own-ship has selected a desired altitude that is above the other aircraft. The text window 120 within the linking box 118 indicates that ITP separation is valid/okay. The processor 24 calculates when an ITP climb associated with the column of space identified by the linking box 118 will no longer be valid. The position where the ITP climb is determined to no longer be valid is identified visually by an icon 140 located in the bottom-right corner of the linking box 118. Adjacent (e.g., below) the linking box 118 is an associated time or distance window 142 that presents the calculated time or distance at which an ITP climb will no longer be valid.

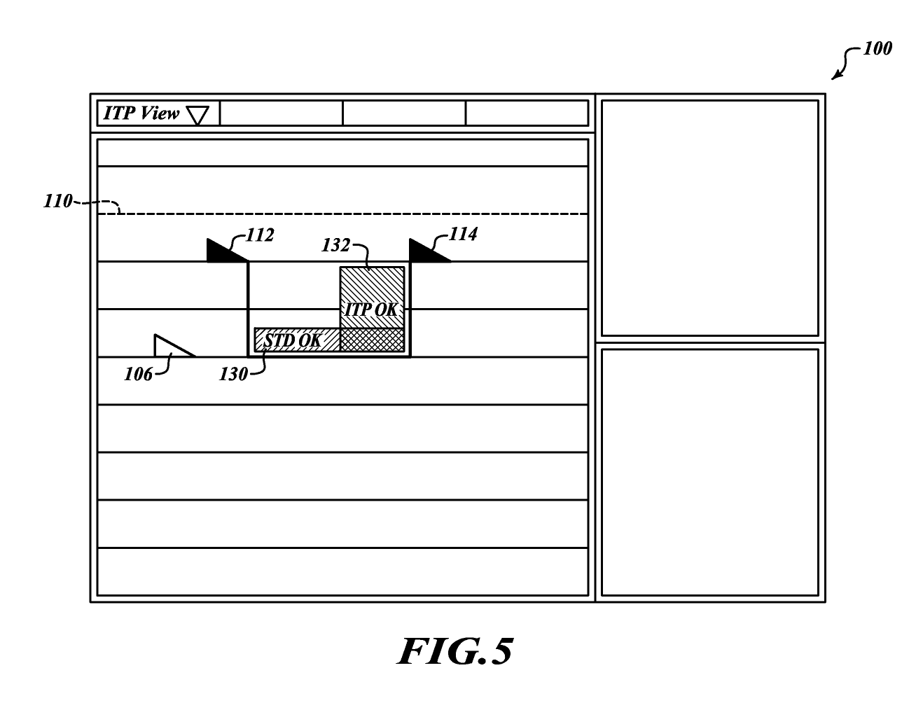

FIG. 5 illustrates a situation where the processor 24 determines that a volume of space between other aircraft is valid for a transition to a desired altitude for an own-ship, as indicated by the own-ship icon 106, at different times for an STD transition than for an ITP transition. In this example, the linking box 118 includes a first text box 130 that indicates that the STD separation is okay and a second text box 132 that indicates that the ITP separation is okay. In one embodiment, these two text boxes 130, 132 are identified with different shading and/or color.

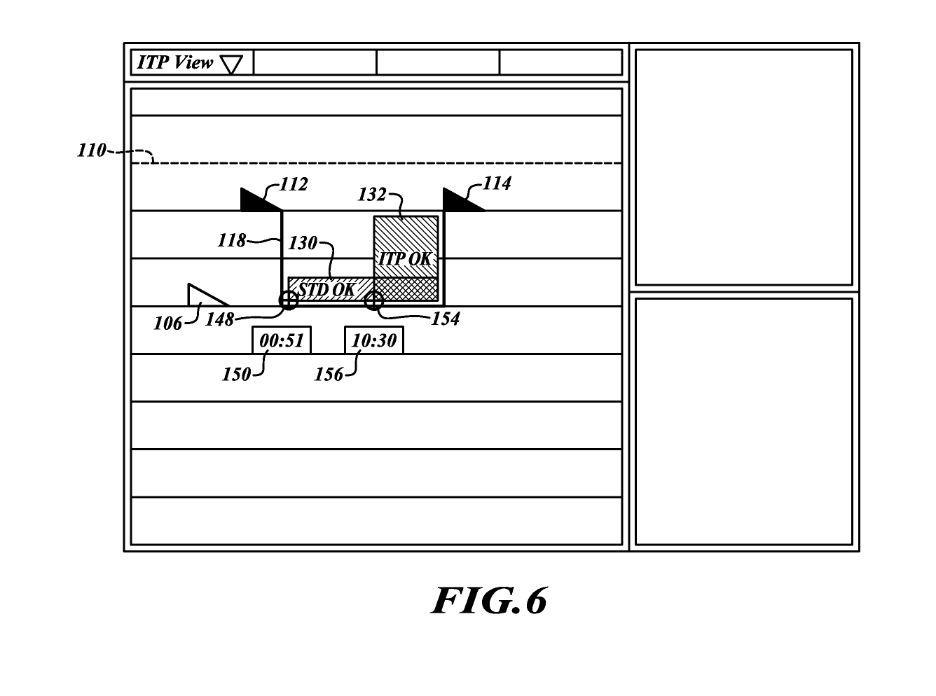

FIG. 6 is similar to FIG. 5, except that the STD separation text box 130 includes an icon 148 at its lower-left corner and a time/distance window 150 is displayed below the icon 148. The time/distance window 150 indicates the time and/or distance when the associated STD transition to the desired altitude is valid. The second text window 132 includes an icon 154 at the lower-left corner and an associated time/distance window 156 that indicates time and/or distance when the ITP transition between the two other aircraft is valid to the desired altitude.

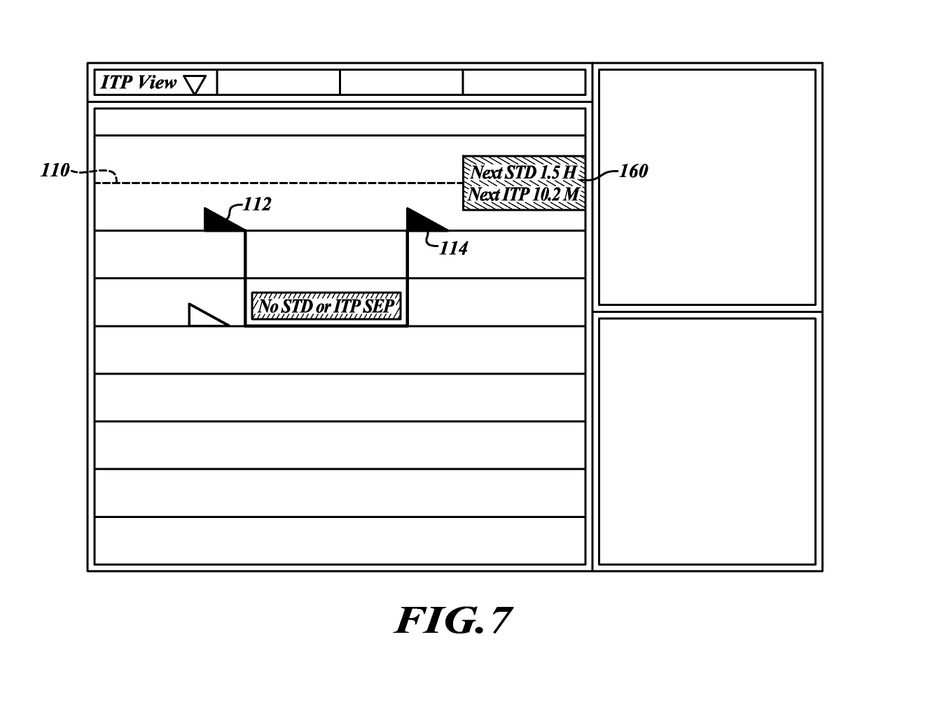

FIG. 7 presents a message box 160 at the far-right end of the selected desired altitude line 110 for indicating when the next STD and/or ITP transition is valid outside of the range visibly present within the vertical profile view section 102. The message box 160 indicates either time or distance as to when the next STD or ITP transition is valid. In one embodiment, the color or shading of the message box 160 is similar to that for the valid indication, such as that shown in the text window 120 of FIG. 4.

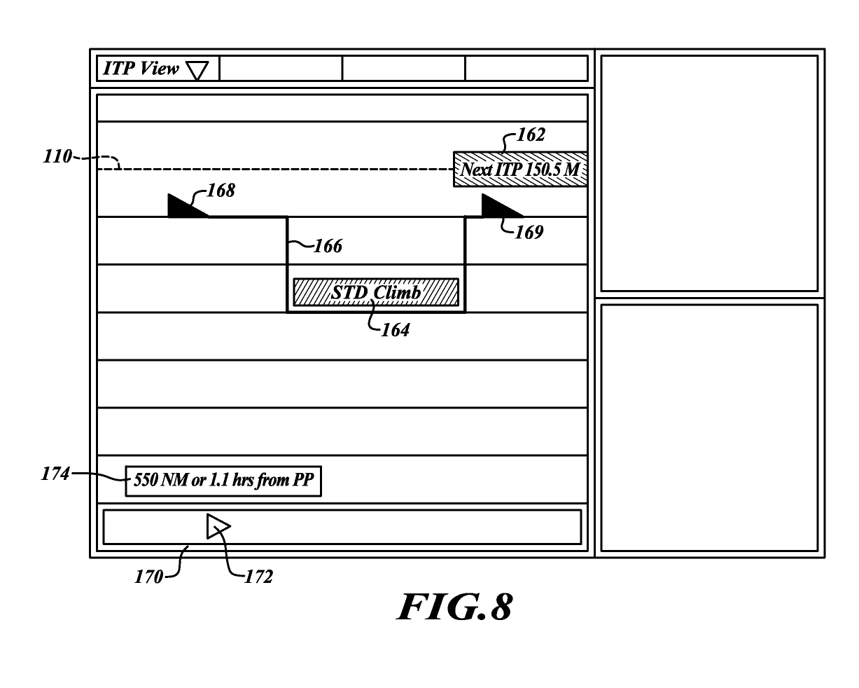

In one embodiment, the message box 160 is presented only when there does not exist a valid STD or ITP transition within the currently viewed vertical profile view section 102. Located at the bottom of the vertical profile view section 102, as shown in FIG. 8, is a time/distance scale 170 that includes a timeline or distance locator icon 172. When the timeline or distance locator icon 172 is at the far left of the scale 170, the vertical profile view section 102 shows the own-ship icon 106 (FIG. 2) and any other icons associated with other aircraft or weather anomalies that would fit within the scale of the vertical profile view section 102 relative to the own-ship's current position. At other positions on the scale 170, the vertical profile view section 102 presents any icons associated with aircraft and/or weather and any valid (or invalid) STD or ITP transitions to the desired altitude, such as that described above, based on a time or distance of the icon 172 from the own-ship's current position. Thus the locator icon 172 can be manipulated by the pilot in order to show what is ahead of the aircraft when the pilot activates the locator icon 172 and slides it along the time/distance scale 170. A text window 174 appears above the locator icon 172 to indicate the location of the contents (aircraft, weather) currently displayed in the vertical profile view section 102. The indicated location in the text window 174 is relative to the own-ship's current location. In this example, the icon 172 and the current contents of the vertical profile view section 102 are located 550 nautical miles (NM) or 1.1 hours from the present position (pp) of the own-ship.

Also shown in FIG. 8, a message box 162 shows when the next ITP transition will be valid. The message box 162 is presented in a similar location as message box 160 shown in FIG. 7. The values located in the message box 162 are relative to the own-ship's current location. In this example, the next STD valid transition is not presented because there exists a valid STD transition as indicated by a text window 164 that is included within a linking box 166 between two other aircraft icons 168, 169.

In this example, the STD transition is not valid until some distance after the location of the left aircraft (the icon 168). Thus, the leading edge of the linking box 166 is located at some distance between the two icons 168, 169. The distance where the leading edge (or trailing edge) is located is where the STD transition is valid, as determined by the processor 24.

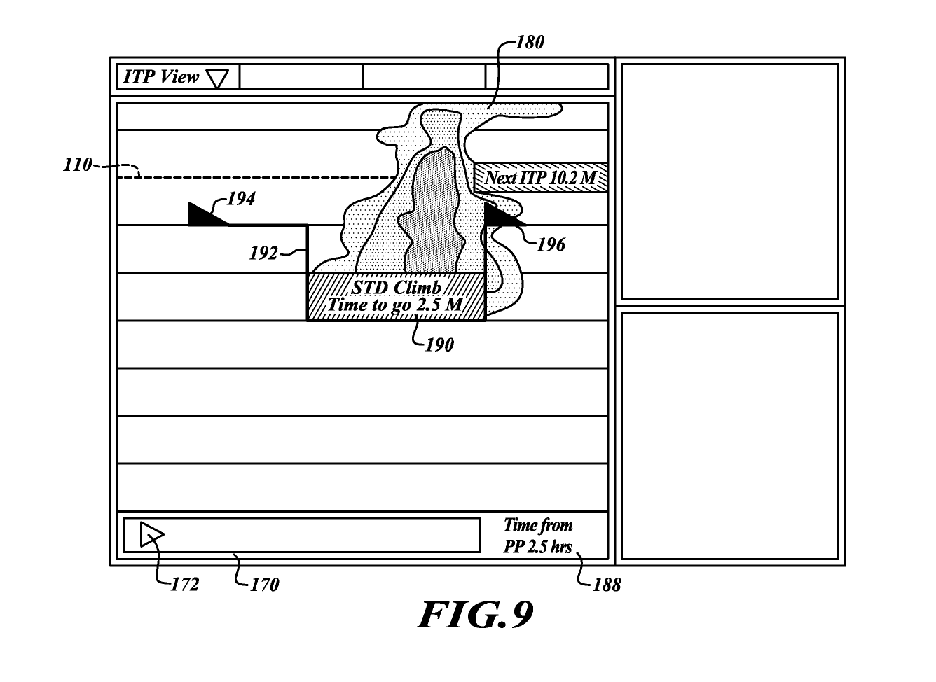

As shown in FIG. 9, the icon 172 has been located along the timeline 170 at a point where a valid STD transition is presented in a text box 190 within a linking box 192 between two aircraft icons 194, 196. Also shown in the vertical profile view section 102 is a weather cell 180, based on weather data stored in the memory 34. Other weather anomalies may be presented here. In this example, the weather cell 180 is positioned at the location where the STD transition would occur. Thus, a pilot would most likely desire to not perform this STD transition in order to avoid the weather hazard.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method performed by a system located on a host aircraft, the method comprising:
receiving at a user interface located on the host aircraft a user selection of a desired altitude;
receiving information from one or more proximate target aircraft via a communications system on the host aircraft;
receiving host aircraft information from one or more other systems located on the host aircraft; and
at a processing device on the host aircraft, generating a graphical user interface display for presentation on a display coupled to the processing device, the graphical user interface display comprising a vertical profile view,
wherein the vertical profile view comprises at least one of a valid or invalid indication for at least one of an In-Trails Procedure (ITP) or standard (STD) transition to the altitude associated with the received desired altitude based on the received proximate target aircraft and host aircraft information.

2. The method of claim 1, wherein the indication comprises a message box, wherein the message box is positioned in the vertical profile view based on the position of a region of airspace associated with the message box.

3. The method of claim 2, wherein the indication comprises a boundary box based on the region of airspace associated with the message box.

4. The method of claim 3, wherein the indication comprises a valid warning indicator configured to present at least one of time or distance information of when the at least one of the ITP transition or the STD transition to the altitude associated with the received desired altitude will be valid.

5. The method of claim 3, wherein the indication comprises an invalid warning indicator configured to present at least one of time or distance information of when or where the at least one of the ITP transition or the STD transition to the altitude associated with the received desired altitude will be invalid.

6. The method of claim 1, wherein the indication comprises a message indicating when at least one of the ITP transition or the STD transition will be valid in a region of space not currently being displayed in the vertical profile view.

7. The method of claim 1, wherein the graphical user interface display comprises a component configured to allow a user to advance the vertical profile view to display information outside of a predefined limit from the host aircraft's current position.

8. The method of claim 1, further comprising:
receiving weather information from a weather system; and
presenting at least a portion of the received weather information on the vertical profile view based on location information associated with the received weather information.

9. A system comprising:
a means for receiving at a user interface located on a host aircraft a user selection of a desired altitude;
a means for receiving information from one or more proximate target aircraft via a communications system on the host aircraft;
a means for receiving host aircraft information from one or more other systems located on the host aircraft; and
a means for generating a graphical user interface display for presentation on a display of the host aircraft, the graphical user interface display comprising a vertical profile view,
wherein the vertical profile view comprises a valid or invalid indication for at least one of an In-Trails Procedure (ITP) or standard (STD) transition to the altitude associated with the received desired altitude based on the received proximate target aircraft and host aircraft information.

10. The system of claim 9, wherein the indication comprises a message box, wherein the message box is positioned in the vertical profile view based on the position of a region of airspace associated with the message box.

11. The system of claim 10, wherein the indication comprises a boundary box based on the region of airspace associated with the message box.

12. The system of claim 11, wherein the indication comprises a valid warning indicator configured to present at least one of time or distance information of when the at least one of the ITP transition or the STD transition to the altitude associated with the received desired altitude will be valid.

13. The system of claim 11, wherein the indication comprises an invalid warning indicator configured to present at least one of time or distance information of when or where the at least one of the ITP transition or the STD transition to the altitude associated with the received desired altitude will be invalid.

14. The system of claim 9, wherein the indication comprises a message indicating when at least one of the ITP transition or the STD transition will be valid in a region of space not currently being displayed in the vertical profile view.

15. The system of claim 9, wherein the graphical user interface display comprises a component configured to allow a user to advance the vertical profile view to display information outside of a predefined limit from the host aircraft's current position.

16. The system of claim 9, further comprising:
a means for receiving weather information from a weather system; and
a means for presenting at least a portion of the received weather information on the vertical profile view based on location information associated with the received weather information.
